(19) United States
(12) Patent Application Publication
(10) Pub. No.: US 2013/0240627 A1
(43) Pub. Date: Sep. 19, 2013

(54) Method and Reader for Capturing a Plurality of Two-Dimensional Codes which are Presented in Succession on a Display Apparatus

(71) Applicant: SIEMENS AKTIENGESELLSCHAFT, Muenchen (DE)

(72) Inventors: George MAMALADZE, Nurnberg (DE); Lars Mehrmann, Langenzenn (DE)

(73) Assignee: Siemens Aktiengesellschaft, Muenchen (DE)

(21) Appl. No.: 13/796,519

(22) Filed: Mar. 12, 2013

(30) Foreign Application Priority Data
Mar. 13, 2012 (EP) EP12159137

(51) Int. Cl. G06K 7/14

(52) U.S. Cl. CPC G06K 7/1456
USPC 235/462.09

(57) ABSTRACT

A method, reader and computer program product for capturing two-dimensional codes presented in succession on a display apparatus, wherein the two-dimensional codes are captured by a plurality of shots from a camera and are decoded by an evaluation device. Here, a shooting rate of the camera for capturing the shots having the codes is higher than a rate of change of the presented codes, wherein in the event of a change of the presented code a subsequently presented code is presented having a changed orientation in relation to the respective previously presented code, and wherein before decoding a code from a shot the orientation of the code in the respective shot is respectively ascertained, where decoding is performed only when the captured code has an orientation that has changed in relation to the most recently successfully decoded code.

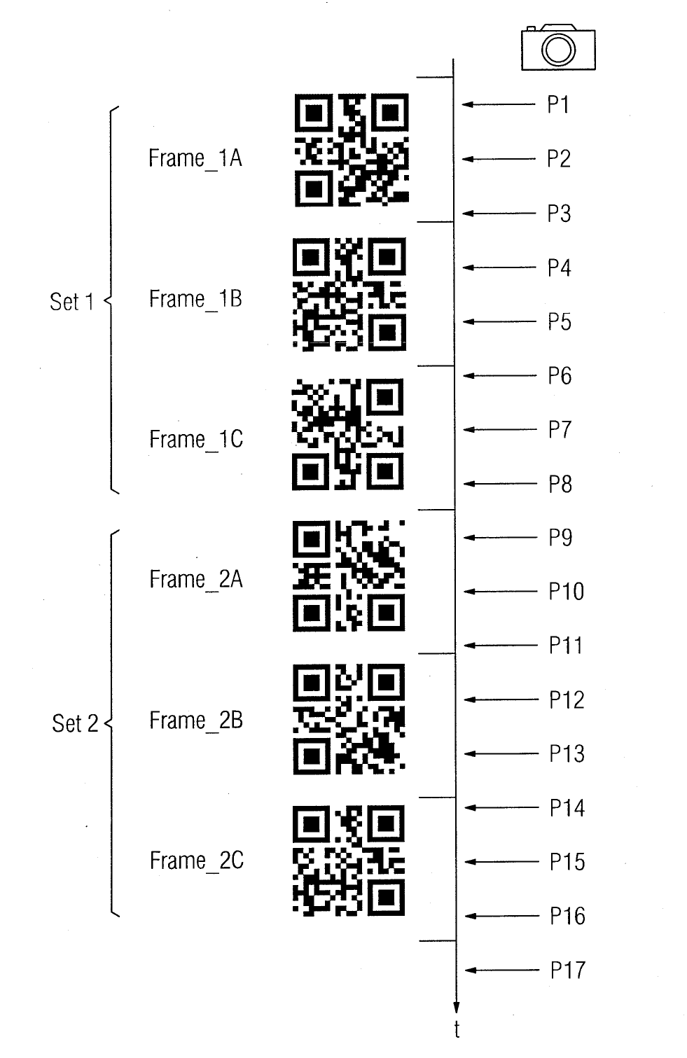

### BACKGROUND OF THE INVENTION

1. Field of the Invention

The invention relates to a method for capturing a plurality of two-dimensional codes which are presented in succession on a display apparatus, a reader for a plurality of two-dimensional codes which are presented in succession on a display apparatus, and to an appropriate computer program product.

2. Description of the Related Art

For the purpose of providing information and transmitting information to technical units, what are known as “optical codes” are often used, that is to say representations which are machine-readable and are often easier to process in comparison with plain text, have a higher level of redundancy (“robustness”) and often also contain a higher density of information. A known example of a “one-dimensional” optical code is the known barcode, with a number of characters being coded into a sequence of bars of different width. By way of example, barcodes are known from packages in retail (EAN—retail item numbering).

In the meantime, increasing use is being made of two-dimensional codes, the best known representative of which is the “Quick Response Code” (QRC), which was developed by the Denso company. These QRCs are known from their use in periodicals and on other publications for publishing URLs for accessing further information. Furthermore, such and other two-dimensional codes are known from railway tickets, boarding cards in air travel, from goods flow systems and from numerous other applications.

Whereas special readers, for example based on LED technology or on laser technology (for example at supermarket checkouts), are frequently used for the known barcodes, the two-dimensional codes are frequently captured by readers which contain a conventional camera. Thus, the URLs presented as QRC codes in periodicals, etc., are frequently photographed using mobile telephones, with the mobile telephones comprising a special program, usually what is known as an “app”, for evaluation and for branching to the appropriately stored URL. This first of all involves the image being captured with a camera, after which an image region is ascertained which contains the two-dimensional code. Said two-dimensional code is digitized, with a threshold value which is used to distinguish between the binary states (logic zero, logic one) needing to be established. Thus, this process translates the image region having the two-dimensional code into a “bar representation”, that is to say into a binary representation. The image detail having the code is then rotated into a defined orientation, after which an evaluation device finally decodes the optically captured information to produce the useful data.

To this end, the two-dimensional codes regularly contain features which can be used to establish the orientation of the representation in relation to a reference plane or reference axis. This allows an optical code picked up with any orientation of the camera to be rotated or reoriented such that it can be evaluated.

Further optical features ensure that distortions in the representation can be recognized and corrected in the shot, as a result of which the original code can be restored and read or evaluated, that is to say decoded, even in the case of a shot with a distorted perspective and in the case of other geometric defects.

The two-dimensional codes are regularly provided with redundancy; this means that it is still possible to restore the useful content even when there are individual errors in the shot. Various redundancy levels can be produced for the cited QR codes; depending on the level used, it is possible to compensate for up to 30% loss. If disturbances arise which it is no longer possible to compensate for, the capture of the code needs to be repeated; customary readers provide a user with feedback about whether or not a read operation was successful.

The quantity of data which can be coded in a two-dimensional code is dependent on the size of the code and on the redundancy level that has been set, but is naturally subject to general limitation. Therefore, many two-dimensional codes, including in the aforementioned Quick Response Code Standard inter alia, have provision for a plurality of codes to be combined to produce an overall data record. By way of example, these may be printed next to one another or below one another and can be captured in succession by a reader, in which case the reader uses a consecutive identifier, for example, to assemble the individual data records to produce an overall data record. Similarly, it is also possible to present a sequence of associated two-dimensional codes at the same location on a display device (e.g. screen), but with a correspondingly powerful reader having to be provided in order to be able to read and evaluate the sequence of codes at an appropriate evaluation rate. In order to ensure that the whole sequence of two-dimensional codes is safely captured, it is customary in this context to use a higher evaluation rate than the rate of change of the presented codes. This is important particularly because firm synchronization between the presenting and evaluating units cannot be ensured, which means that usually at least double, but often even more frequent, “oversampling” is used. This is also important on account of the fact that individual shots may be erroneous and undecodable. Whereas industrial applications involve the provision of appropriately powerful readers, particularly having appropriately powerful evaluation devices, for this purpose, simple readers, particularly the “smartphones” that are often used by consumers, are often unable to process the “data streams” transmitted by a sequence of two-dimensional codes at a sufficient speed in a case of multiple oversampling. A correspondingly lower evaluation rate causes a higher susceptibility to error, however.

### SUMMARY OF THE INVENTION

It is thus an object of the present invention to reliably read data records and data streams which are represented via a sequence of two-dimensional codes also using readers that are not very powerful.

It is a central idea to achieve the object of being able to save computation time in an evaluation unit and hence of also being able to use less powerful evaluation units or readers when unnecessary evaluation operations are not carried out. In the case of “oversampling”, that is to say in the case of a higher capture rate in comparison with the rate of change of the presented two-dimensional codes, the invention thus requires a code to be decoded completely only if it differs from the most recently successfully decoded code, that is to say that a change has taken place in the meantime. In the case of the customary data records which are distributed over multiple codes or in the case of the customary “data streams” comprising two-dimensional codes, the prior art requires a shot and the code contained therein to be evaluated completely, for example in order to use a consecutive number or to use another descriptor which is present in the code to establish whether this is an already decoded code, that is to say a repeat shot and repeat evaluation, or whether the code has changed in the meantime, that is to say that a subsequent “frame” is present which needs to be decoded completely. The invention thus makes use of the insight that the customary two-dimensional codes allow the use of essential, easy-to-evaluate geometric features to establish the orientation of the code on an image or in relation to a reference axis or reference plane. According to the invention, for every change of the code in the representation, the orientation needs to be changed, so that only in the case of an orientation that has changed is it possible to assume that the code has also changed, that is to say that a subsequent code (frame) with a new content needs to be read. In this case, it is a prerequisite that a change in the perspective orientation of a camera, or a rotation of a camera, in relation to a presentation unit is performed more slowly or at a lower rate of change than a deliberate change in the orientation in the representations. It is a further aspect according to the invention that, for essential, time-consuming steps of the evaluation, particularly for establishing that region of an image in which the code is presented, and with what threshold value said code can be digitized or converted into a bar representation, this can be adopted from previous evaluations as starting values. As a result, the number of necessary iterations can be decreased. This is likewise based on the assumption that there is only a slow change in the exterior conditions, particularly an interval between a camera and a presentation unit, the orientation of the camera in relation to a presentation unit, the exterior lighting or brightness of the representation, etc. This allows even low-power readers, such as mobile telephones or “smartphones”, to evaluate data streams from two-dimensional optical codes at a comparatively high data rate.

These and other objects and advantages are achieved in accordance with the invention by a method for capturing a plurality of two-dimensional codes which are presented in succession on a display apparatus, wherein the two-dimensional codes are captured via a plurality of shots from a camera and are decoded via an evaluation device. In this case, a shooting rate of the camera for capturing the shots having the codes is higher than a rate of change of the presented codes, wherein in the event of a change of the presented code a subsequently presented code is presented having a changed orientation in relation to the respective previously presented code, and wherein prior to decoding of a code from a shot the orientation of the code in the respective shot is respectively ascertained, wherein decoding is performed only in those cases in which the captured code has an orientation that has changed in relation to the most recently successfully decoded code. This method allows the processing speed to be increased and the computation load for an evaluation unit to be decreased by avoiding unnecessary decoding, that is to say the unnecessary recovery of the useful content, when the same two-dimensional code (frame) has already been evaluated.

The object is furthermore achieved by a reader for capturing a plurality of two-dimensional codes which are presented in succession on a display apparatus, wherein the two-dimensional codes are captured by means of a plurality of shots from a camera, and wherein said two-dimensional codes are decoded by means of an evaluation device in the reader. In this case, the reader is set up to process a shooting rate of the camera, wherein the rate for capturing the shots having the codes is higher than a rate of change of the presented codes, wherein the reader is set up so that in the event of a change of the presented code a subsequently presented code is presented having a changed orientation in relation to the respective previously presented code, and wherein the reader is set up such that prior to decoding of a code (frame) from a shot it respectively ascertains an orientation for the code (frame) in the respective shot, wherein the reader is set up such that decoding is performed only in those cases in which the currently captured code (frame) has a changed orientation in relation to the most recently successfully decoded code (frame). Such a unit can provide the advantages of the method according to the invention.

In addition, the object is achieved by a computer program product on a computer-readable storage medium or on a server which can be accessed by a computer, having executable program code or having source or intermediate code which can be compiled to produce an executable program code, wherein the computer program product is designed to interact with a piece of computer hardware and a camera or an externally captured image data stream in order to perform one of the methods cited above, provided that the program code is executed on the computer hardware.

Following capture of a shot, an image region is first of all ascertained which contains the transmitted two-dimensional code. In one advantageous refinement, the image region ascertained for a previous shot is used as a starting value for ascertaining the image region for a subsequent shot that is currently to be evaluated, with the result that the computation complexity required for ascertaining the image region is decreased and possibly the number of iteration steps required is decreased. The same applies to the or at least one threshold value which is used in the case of grayscale and color shots to convert the image region having the two-dimensional code into a binary representation (bar representation), that is to say which is used to distinguish between logic zeros and logic ones. In this case too, the threshold value used for previous shots can be used as a starting value for the current digitization, because it is assumed that in the case of successive shots neither the image region nor the exposure and hence the threshold value change significantly. For minor changes, the adaptation of the threshold value can take place more quickly or is often even unnecessary. In this case, the invention also relates to multicolored two-dimensional codes, for the evaluation of which there is then a respective threshold value calculation in the respective color spectrum; that is to say that a dedicated threshold value is determined for each spectral color used in the code. Depending on the method of evaluation, a separate “black-and-white image” is then also extracted (for example by digital color filtering) and separately decoded for each spectral color used in the code, for example.

Advantageously, the two-dimensional code used is a QR code. The reason is that the known QR codes allow the use of three significant squares to establish the orientation of the code very easily and hence without a high level of computation complexity without needing to decode the code completely. In principle, however, it is possible to use other two-dimensional codes too. Finally, it is also possible to use codes which comprise further dimensions besides the two cited dimensions, for example as a result of three-dimensional or multicolored representation. Such multidimensional codes also comprise at least two dimensions and can advantageously be processed using the method according to the invention.

Advantageously, the plurality of two-dimensional codes is used to transmit a data stream and/or a quantity of data which goes beyond the data volume of an individual code, and as the quantity of data rises there is also an advance in the decrease in the complexity of the processing that can be attained by the method. In one advantageous refinement, it is furthermore possible to divide the codes into what are known as “sets” containing a respective plurality of individual codes, and this makes it possible, inter alia, to present complete sets multiple times, that is to say repeatedly, increasing the “robustness” of the data transmission. Furthermore, it is possible for the frames in one and the same set to be provided with a conspicuous and hence easily automatically evaluatable additional marker, so that it is a simple matter to distinguish between the codes or frames of different sets without having to evaluate completely each of the frames relating to this. This allows such repeated sets to be ignored completely if they have already been received in full and successfully.

The method is particularly suitable for implementation on a unit with comparatively little available computation power, such as a mobile telephone (smartphone), a tablet PC or the like. Particularly in the case of mobile telephones, computers and tablet PCs from the consumer sector, it is particularly advantageously possible in this context to implement the method using what is known as an “app” (application), which can easily be installed and uninstalled. Precisely the “apps” which are known for units in the consumer sector can be installed and uninstalled by means of a simple operating procedure even by novices. Alternatively, it is also possible to implement the method in a piece of firmware on a unit or even directly in an image processor of a camera.

In one advantageous embodiment, the camera is part of the reader; this is usually the case anyway in modern “smartphones”, for example. In one alternative refinement, however, it is also possible for an evaluation unit (reader) to access a series of images (image data stream) from an external device or camera. In this case, it is particularly possible to operate a plurality of cameras in an evaluation system, with the image evaluation and the decoding of the resulting image data streams being performed by a central device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the method according to the invention is explained below with reference to the drawing. At the same time, this exemplary embodiment is used to explain a reader according to the invention and a computer program product according to the invention.

### DETAILED DESCRIPTION OF THE PREFERRED EMBODIMENTS

In this context, the single FIGURE shows a sequence of two-dimensional codes (frames), with the capture times of shots from a camera being presented simultaneously.

The figure shows, along a time axis t, a series of six two-dimensional codes Frame_1A, . . . , Frame_2C which are presented in succession, these codes Frame_1A, . . . , Frame_2C being presented on a display apparatus (not shown) in temporal succession for a respective stipulated period of time. In this case, the codes are used for transmitting a data stream, with the exemplary codes shown here containing their descriptor “Frame_1A” . . . “Frame_2C” as useful content. In a real arrangement, however, it would therefore also be possible to transmit individual images, data records, etc. The codes are organized in two sets Set1, Set2, which is an optional embodiment that is explained later. On the right-hand side of the figure, horizontal arrows are used to mark those times on the time line t at which a shooting apparatus (camera) shoots the screen content of the display apparatus (not shown); in this case, shots P1, . . . , P17 (“picture”) are taken by means of the camera and are supplied to an evaluation device (not shown). An essential aspect in this case is that the rate of change of the codes is lower than the shooting rate of the camera; in the present example, sixteen shots are thus produced in a period in which six different codes (frames) are presented. This is an exemplary presentation; in a real presentation, the shooting rate may be even higher, for example, on the basis of the presentation rate, which means that in such a case the positive effect of the method according to the invention becomes even more clearly apparent.

It will now be assumed that the first shot P1 is produced and is supplied to the evaluation device. To this end, the image region having the code Frame_1A is first of all sought and found in a larger image, namely the complete shot. A threshold value for digitizing the presented pattern is then ascertained, the dimensions of the threshold value needing to be such that the pattern having just two states (black-and-white pattern) which is shown in the figure is obtained from a color shot or a grayscale shot. A step which is not discussed further here additionally involves the correction of perspective distortions, pincushion distortions or the like. The three large squares in the top left, bottom left and top right corners can now be used to establish the orientation of the “frame”; to this end, it is possible to form a triangle from the three black squares, for example. If this triangle is not an isosceles triangle, perspective distortion exists which needs to be corrected; therefore, the step of perspective distortion can be combined with the step of establishing the orientation. If the orientation is not based on a standard, for example, the orientation shown by means of the code Frame_1A, the edited image detail is now also rotated such that the “standard orientation” is obtained. Next, the edited code is decoded by the evaluation device, i.e. the useful content (in this case “Frame_1A”) is restored. In this respect, the processing of the shot is based on the prior art.

According to the invention, during the processing of this first code Frame_1A, the (original) orientation is stored, for example in the form of an angle (value between 0° and 30°) by which the presented code Frame_1A was rotated in the shot in comparison with the “standard position”. For advantageous embodiments of the invention, the threshold values for converting a color image or a grayscale image into an evaluatable form, for example, into a bar graph (black-and-white conversion), and a piece of information about the image segment in which the code Frame_1A was found, for example, using the descriptor of a quadrant or using absolute image coordinates, are additionally also stored during the processing. Optionally, it is also possible to store parameters for correcting distortions and to reuse them for later shots.

It will subsequently be assumed that the decoding performed using the shot P1 was successful; this means that a checksum, “CRC” (CRC—Cyclic Redundancy Check), or the like has been used to verify that the useful content “Frame_1A” has been captured correctly. The subsequent shot P2 is then evaluated. This is done in a similar manner to the shot P1, specifically up to the step in which the orientation of the code is established. Since the shot P2 is the same presented frame, that is to say the code Frame_1A, it also has the same kind of orientation in relation to the preceding shot P1. By way of example, discrepancies can result from a camera being held manually or the camera and the display apparatus being unintentionally rotated relative to one another for other reasons. The distinction (difference) between the orientation of the code Frame_1A in the shots P1 and P2 is therefore compared with a limit value, for example 20°. If the difference is below this limit value, a reader or an evaluation device assumes that one and the same code Frame_1A is involved, which means that further evaluation, particularly complete decoding of the content, does not need to be performed. In this context, the limit value (in this case: 20°) is stipulated such that it is usually possible to ignore unintentional rotations which occur between two successive shots, but on the other hand intentional changes in the orientation between the codes Frame_1A, . . . , Frame_2C can very probably be established. Advantageously, such a limit value can also be automatically determined and adjusted or tracked “adaptably” in the course of operation.

Following termination of the evaluation of the shot P2, the shot P3 is now processed in the same way, with it likewise being possible to establish no significant change in the orientation because the image content of the shot P3 continues to show the code Frame_1A. This is different in the case of the shot P4, however. In this case, the evaluation establishes that the “missing” square is no longer arranged at the bottom right but rather is arranged at the bottom left in the presentation, which corresponds to a rotation of 90°, which is therefore higher than the stipulated limit value of 20°. Hence, it is assumed that a “new”, that is to say as yet unread, code Frame_1B is involved which therefore needs to be decoded completely. If the decoding fails, for example, on account of a lack of image quality, it is reattempted using the shot P5. Otherwise, that is to say if the shot P4 has been able to be evaluated successfully, the processing of the shot P5 stops at the point at which it is established that there is no significantly changed orientation of the presented code Frame_1B in comparison with the most recently successfully evaluated shot P4.

The method is then continued, and in one advantageous refinement, following the presentation and capture of the frame group Set1, this can also be repeated once again for safety reasons.

Although the decoding shown has been explained using the QR code (Quick Respond code), other two-dimensional codes are naturally also suitable. Even such codes as have a spatial orientation that cannot be determined from exterior features can have elements added, during the presentation on a display apparatus, outside the actual code, which are able to be used to define an orientation or to detect a change in the orientation. In the case of a—theoretically—rotationally symmetrical code, it would thus even be possible, when a first “frame” is displayed, for a distinct point, square or the like to be presented at a first location, such as at 0° (top), outside the actual frame, whereas this point would be displayed at another location, such as at 45°, for a subsequent frame. Such an extended presentation would nevertheless still be able to be read by a noninventive reader, because the very marking of the orientation would be performed outside the “useful regions” of the code and hence is not a disturbance for the evaluation. In other words: the use of the method according to the invention does not result—even with codes which are a priori less suitable—in such a code needing to be altered contrary to the respective standard.

In advantageous embodiments, as stated, the threshold values and image segments/quadrants or the like which have been established during previous evaluations are advantageously used as starting values or points of reference for subsequent evaluations. All of these measures speed up the evaluation, which means that the computation time “saved” in the process can be used for other processes of a unit or correspondingly less powerful hardware can actually be used in the first place. The described identification and rejection of “duplicates” take place very quickly in this case, since first of all—in the example of the QR code—the three position squares are read, with a “lack of” rotation through 90°, for example, between two images (shots) quickly revealing duplicates even before complete decoding. In alternative embodiments, it is also possible to use “rotation steps” other than the 90° described here by way of example; this applies particularly when it is possible to assume that the camera is oriented more or less statically in relation to a display apparatus. In the latter case, the deliberate alterations may be less pronounced; on the other hand, it is advantageous in the case of square or rectangular codes if they are displayed at right angles to the edges of a display device (monitor, display, etc.), because in such cases the distortions caused by the presentation in the form of individual image points (pixels) are smallest.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for capturing a plurality of two-dimensional codes which are presented in succession on a display apparatus, the method comprising the steps of:
capturing the two-dimensional codes via a plurality of shots from a camera; and
decoding the captured two-dimensional codes by evaluation device;
wherein a shooting rate of the camera for capturing the shots having the codes is higher than a rate of change of the presented codes;
wherein in an event of a change of a presented code a subsequently presented code is presented having a changed orientation in relation to a respective previously presented code; and
wherein prior to decoding of a code from a shot the orientation of the code in a respective shot is respectively ascertained, decoding being performed only in those cases in which captured code has an orientation that has changed in relation to a most recently successfully decoded code.

2. The method as claimed in patent claim 1, wherein following capture of a shot a respective image region having the code is ascertained in the shot; and wherein an image region ascertained for a previous shot is used as a starting value for ascertaining an image region for a subsequent shot.

3. The method as claimed in patent claim 1, wherein following capture of a shot the captured code is converted into a binary representation by ascertaining at least one threshold value for distinguishing between the binary states; and wherein a threshold value ascertained for a previous shot is used as a starting value for ascertaining a threshold value for a subsequent shot.

4. The method as claimed in patent claim 1, wherein the two-dimensional codes used are quick response (QR) codes.

5. The method as claimed in patent claim 1, wherein the plurality of codes is used to transmit at least one of a data stream and a quantity of data which extends beyond a data volume of an individual code.

6. The method as claimed in patent claim 1, wherein the two-dimensional codes are organized in sets having a respective plurality of codes; and wherein a redundancy for a data transmission is increased by displaying and capturing each of the sets in multiple succession.

7. The method as claimed in patent claim 1, wherein the two-dimensional codes are captured and evaluated by using a mobile telephone.

8. A reader for capturing a plurality of two-dimensional codes which are presented in succession on a display apparatus, wherein the two-dimensional codes are captured by a plurality of shots from a camera, and wherein said two-dimensional codes are decoded by an evaluation device in the reader;
wherein the reader is set up to process the shots at a shooting rate of the camera, the shooting rate for capturing the shots having the codes being higher than a rate of change of a presented codes;
wherein the reader is configured such that in an event of a change of the presented code a subsequently presented code is presented having a changed orientation in relation to the respective previously presented code;
wherein the reader is configured such that prior to decoding of a code from a shot the reader respectively ascertains an orientation for the code in the respective shot; and
wherein the reader is set up such that decoding is performed only in those cases in which a currently captured code has a changed orientation in relation to a most recently successfully decoded code.

9. The reader as claimed in patent claim 8, wherein the reader is configured such that following a capture of the shot the reader ascertains a respective image region having the code in the shot; wherein the reader uses the image region ascertained for a previous shot as a starting value for ascertaining the image region for a subsequent instance of the shots.

10. The reader as claimed in patent claim 8, wherein the reader is configured such that following capture of the shot the captured code is converted into a binary representation by ascertaining a threshold value for distinguishing between binary states; and wherein the reader is configured to use a threshold value ascertained for a previous shot as a starting value for ascertaining a threshold value for processing a subsequent shot.

11. The reader as claimed in patent claim 9, wherein the reader is configured such that following capture of the shot the captured code is converted into a binary representation by ascertaining a threshold value for distinguishing between binary states; and wherein the reader is configured to use a threshold value ascertained for a previous shot as a starting value for ascertaining a threshold value for processing a subsequent shot.

12. The reader as claimed in one of patent claim 8, wherein the reader is configured to process quick response (QR) codes as the two-dimensional codes.

13. The reader as claimed in patent claim 8, wherein the reader comprises a mobile telephone.

14. The reader as claimed in patent claim 8, wherein the camera forms part of the reader.

15. The reader as claimed in patent claim 8, wherein the reader is configured to receive an image data stream from an external camera; and wherein individual images in the image data stream are used as the shots.

16. A computer program product stored on a non-transitory computer-readable storage medium or on a server which is accessible by a computer, including executable program code, source code or intermediate code which is compileable to produce an executable program code that interacts with a piece of computer hardware and a camera or an externally captured image data stream, the computer code comprising:
program code for capturing the two-dimensional codes via a plurality of shots from a camera; and
program code for decoding the captured two-dimensional codes by evaluation device;
wherein a shooting rate of the camera for capturing the shots having the codes is higher than a rate of change of presented codes;
wherein in an event of a change of a presented code a subsequently presented code is presented having a changed orientation in relation to a respective previously presented code; and
wherein prior to decoding of a code from a shot an orientation of the code in a respective shot is respectively ascertained, decoding being performed only in those cases in which the captured code has an orientation that has changed in relation to a most recently successfully decoded code.

17. The computer program product as claimed in patent claim 15, wherein the computer program product comprises a loadable application.

18. The computer program product as claimed in patent claim 17, wherein the loadable application is for one of a mobile telephone and a tablet PC.
